(19) United States
(12) Patent Application Publication
(10) Pub. No.: US 2015/0066775 A1
(43) Pub. Date: Mar. 5, 2015

(54) Transferring Funds Using Mobile Devices

(71) Applicant: Bank of America Corporation, Charlotte, NC (US)

(72) Inventors: Morgan S. Allen, Charlotte, NC (US); Matthew Laine Donlan, Charlotte, NC (US)

(21) Appl. No.: 14/537,518

(22) Filed: Nov. 10, 2014

Related U.S. Application Data
(63) Continuation of application No. 12/700,803, filed on Feb. 5, 2010.

(51) Int. Cl. G06Q 20/32; G06Q 20/40

(52) U.S. Cl. CPC G06Q 20/3224; G06Q 20/40; G06Q 20/3223
USPC 705/44

(57) ABSTRACT

Aspects of this disclosure relate to a method for transferring funds involved in a financial transaction of a customer by utilizing the mobile device of the customer, including determining device identification data for a mobile device, associating the device identification data to a financial account of a customer, receiving a fund transfer request that includes data identifying the mobile device and an amount of funds to transfer from the financial account of the customer to a financial account of the seller, verifying the fund transfer authorization based on the device identification data, and initiating the fund transfer between the customer's financial account and the financial account of the seller.

### CROSS REFERENCE TO RELATED APPLICATIONS

This application is a continuation of and claims priority to co-pending U.S. application Ser. No. 12/700,803, filed Feb. 5, 2010, entitled “TRANSFERRING FUNDS USING MOBILE DEVICES.”

### FIELD OF THE INVENTION

Aspects of the present disclosure relate generally to transactions involving the transferring of funds. Particular aspects of the present disclosure relate to transferring funds involved in a transaction by utilizing a mobile device.

### BACKGROUND

A transaction between a seller and a customer often involves the transferring of funds from the financial institution of the customer to the financial institution of the seller. Some conventional transactions involve particular payment accounts of the customer, such as a credit account and a debit account. In order to process the transaction from the payment account, the transaction may be required to proceed through a third party association or payment network. For example, when a customer purchases a good and/or service using their credit account, a third party payment network (e.g., Visa®, MasterCard®, etc.) processes the transaction between the financial institution of the seller and the financial institution of the customer. Often, the third party association may charge a fee for their processing service. Additionally, the customer, in some cases, is required to carry a card associated with the credit or debit account in order to initiate the purchase. Such third party and card requirements complicate the transaction between the seller and the customer.

Additionally, a customer often carries on their person a mobile device, such as a cell phone, personal digital assistant, etc. Therefore, it would be advantageous to have a system and method for transferring funds involved in a financial transaction of a customer by utilizing the mobile device of the customer.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

In light of the above, it would be advantageous to have a system and method that utilizes the mobile device when completing the transaction. Therefore, aspects of this disclosure relate to a system for transferring funds involved in a financial transaction of a customer by utilizing the mobile device of the customer, including a mobile device, one or more computing systems of a financial institution, one or more databases of a financial institution, and a point of transaction (e.g., a point of sale system) configured to communicate with the mobile device. In one example, the computing systems of the financial institution may begin a user session for a customer, determine device identification data for a mobile device, associate the device identification data to a financial account of a customer, receive a fund transfer request that includes data identifying the mobile device and an amount of funds to transfer from the financial account of the customer to a financial account of the seller, verify the fund transfer authorization based on the device identification data, and initiate the fund transfer between the customer's financial account and the financial account of the seller. The mobile device communicates with the point of transaction to authorize and complete a payment request, wherein the mobile device may transmit data to and/or receive data from the point of sale and/or the financial institution, and the point of sale may transmit data to the financial institution so that the financial institution may initiate the transfer of funds.

Additional aspects of the disclosure relate to a computer assisted method for completing a financial transaction wherein a mobile device is utilized to complete a payment request with a point of transaction. The computer assisted method may determine device identification data for a mobile device. The computer assisted method may associate the device identification data to a financial account of a customer. The computer assisted method may receive a fund transfer request that includes data identifying the mobile device and an amount of funds to transfer from the financial account of the customer to a financial account of the seller. The computer assisted method may verify the fund transfer authorization based on the device identification data, and the computer assisted method may initiate the fund transfer between the customer's financial account and the financial account of the seller.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an exemplary network environment for processing transactions involving the transfer of funds according to one or more aspects of the disclosure.

FIG. 3 is a flow chart illustrating a method for making payment at a point of sale using a mobile device.

FIG. 4 is a flow chart illustrating a method for processing and completing payment for a purchase using a mobile device at a point of sale.

FIG. 5 is an illustration of an exemplary display for a mobile device that may be displayed upon receiving a payment request from a point of sale and/or a payment confirmation request from a financial institution, according to various aspects of the disclosure.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

It is noted that throughout the disclosure, the term bank may be used interchangeably with organization, financial institution, business, etc. The term bank is not intended to be limiting, but rather merely describes a potential embodiment of the disclosure.

Aspects of this disclosure relate to a system and method for transferring funds involved in a transaction. Further, particular aspects of this disclosure relate to a system and method for transferring funds involved in a transaction using a mobile device. When a customer conducts a transaction involving the transferring of funds (e.g., a financial transaction) with a seller (a merchant, a retail store, a service organization, etc.), the seller may provide a particular good and/or service to the customer at a particular price. In some cases, the customer may purchase the particular good and/or service at the particular price using a financial account (e.g., credit account, debit account, checking account, savings accounts, etc.) In cases where a customer uses a financial account, funds are transferred from the financial institution of the customer to the financial institution of the seller. This provides an opportunity to provide a system and method that transfers the desired funds between the financial institutions.

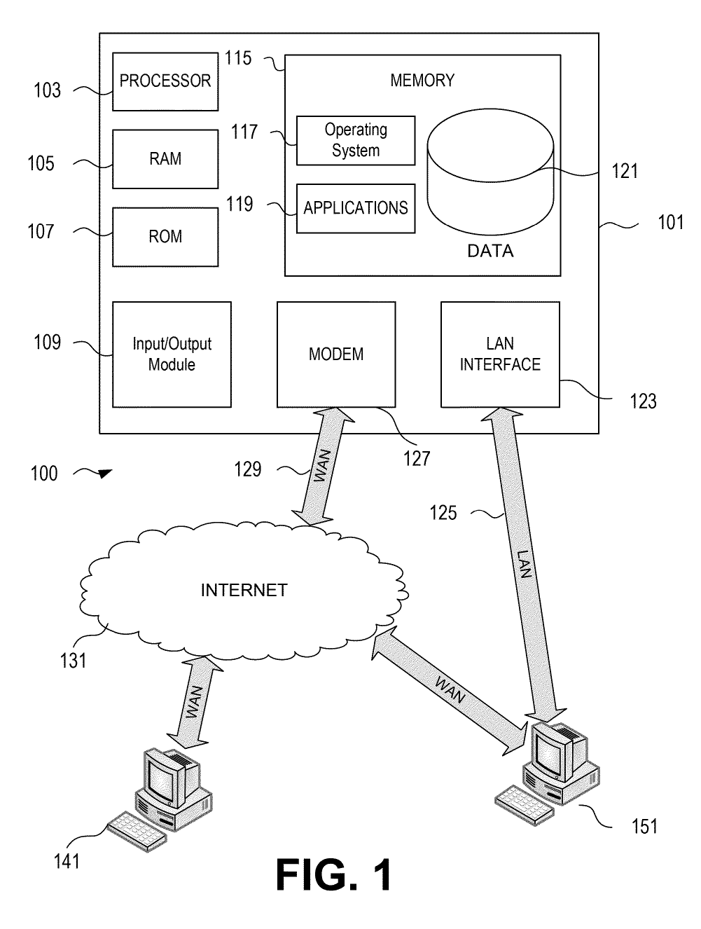

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1A include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

The system, devices and networks of FIG. 1 may, in one or more arrangements, be used to transfer funds involved in a transaction between a customer and a seller (e.g., a retail business/store). Mobile devices of a customer may be utilized to receive payment requests from a communication device of the seller such as a point of sale system in order for the seller to initiate the transfer of funds involved in the transaction. For example, data identifying the mobile device (e.g., a SIM card number, a device serial number, a phone number) may be associated with a particular financial account of the customer at the financial institution; a point of sale system may then identify the mobile device based on the identifying data; the point of sale system may subsequently send a payment request to the mobile device including a requested amount; and the mobile device may transmit a payment authorization to the financial institution of the customer.

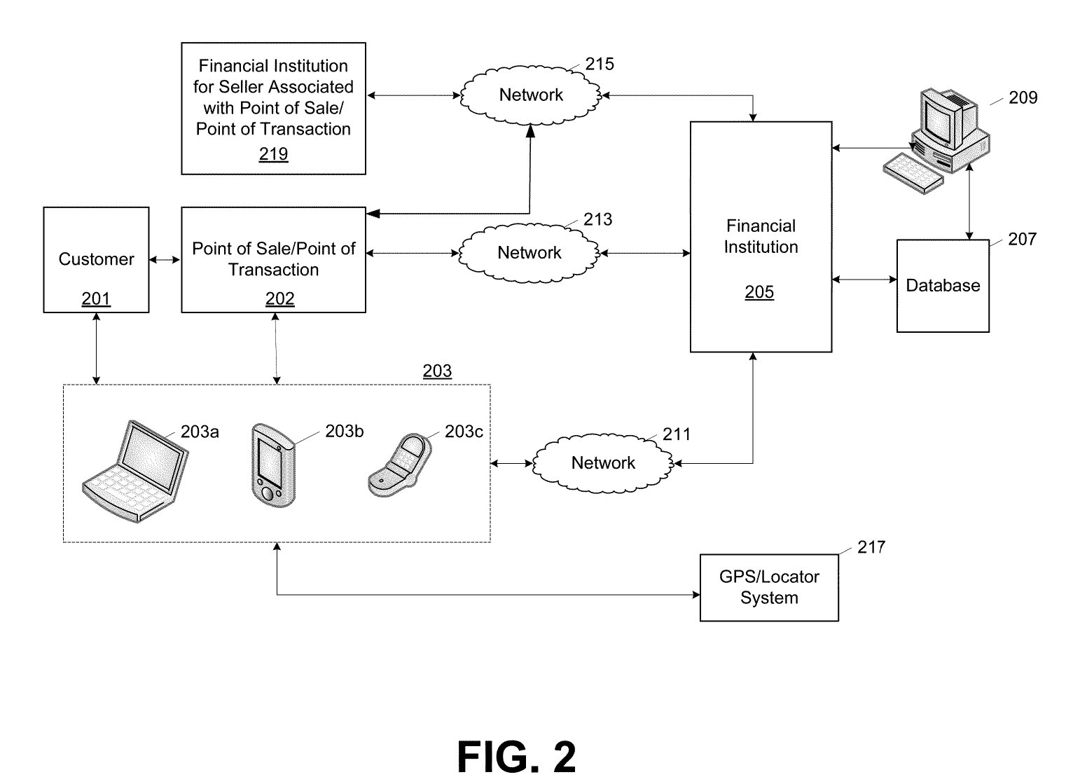

FIG. 2 illustrates an exemplary network environment for processing transactions involving the transfer of funds according to one or more aspects of the disclosure. As seen in FIG. 2, a customer 201 conducts a transaction with a seller at a point of sale/point of transaction 202. According to aspects of this disclosure, the customer may utilize their mobile device 203 in order to conduct the transaction. Therefore, as seen in FIG. 2, mobile device 203 may transmit data to and receive data from the point of sale/point of transaction 202. Mobile device 203 may be a hand-held or laptop device, including, for example, laptop computer 203a, personal digital assistant 203b, and cellular phone/smart phone 203c, etc. Further, as seen in FIG. 2, mobile device 203 may transmit data to and receive data from financial institution 205 through network 211. According to aspects of the disclosure, financial institution 205 may be a bank or other financial institution where customer 201 has a financial account (e.g., a credit account, debit account, savings account, debit account, etc.). Additionally or alternatively, mobile device 203 may be configured to transmit data to and receive data from global positioning system (GPS)/locator system 217 to determine its own location.

Point of sale/point of transaction 202 may be configured to transmit data to and receive data from financial institution 205 through network 213 and may transmit data to and receive data from mobile device 203. Financial institution 205 may hold an account of the retail business associated with the point of sale 202. In one or more configurations, point of sale/point of transaction 202 may include a computing device for processing a financial transaction. For example, point of sale/point of transaction 202 may be a cash register, a personal computer, another mobile device, etc. Data between financial institution 205 and point of sale/point of transaction 202 may be transmitted through network 213. Alternatively or additionally, data such as a payment request may be transmitted from point of sale 202 to financial institution 219 through network 215, which may then be configured to relay the request to financial institution 205. Financial institution 205 may include computing systems such as computing system 209 and institution database 207. The above described system represented in FIG. 2 will be described in more detail below. However, it is noted here that one or more of the elements in the above described system (e.g., point of transaction 202, mobile device 203, financial institution 205, database 207, computing system 209, etc.) may include a computer system with a processor, a memory or both.

According to aspects of the disclosure, a financial transaction may be a transaction involving customer 201 and a seller or retail business where point of sale 202 is located. Customer 201 may provide a particular amount of funds for a particular good and/or service sold by the retailer (e.g., a merchant, a retail store, a service organization, etc.). For example, customer 201 may conduct a financial transaction at the point of transaction 202 of the seller to purchase a good being sold by the seller, such as an article of clothing, food items, etc. In another example, customer 201 may conduct a financial transaction at the point of transaction 202 of the seller to purchase a service being offered by the seller, such as dry cleaning, salon services, etc. It is noted that a financial transaction can involve any good or service offered by the seller wherein the customer 201 provides an amount of funds as a means of purchase.

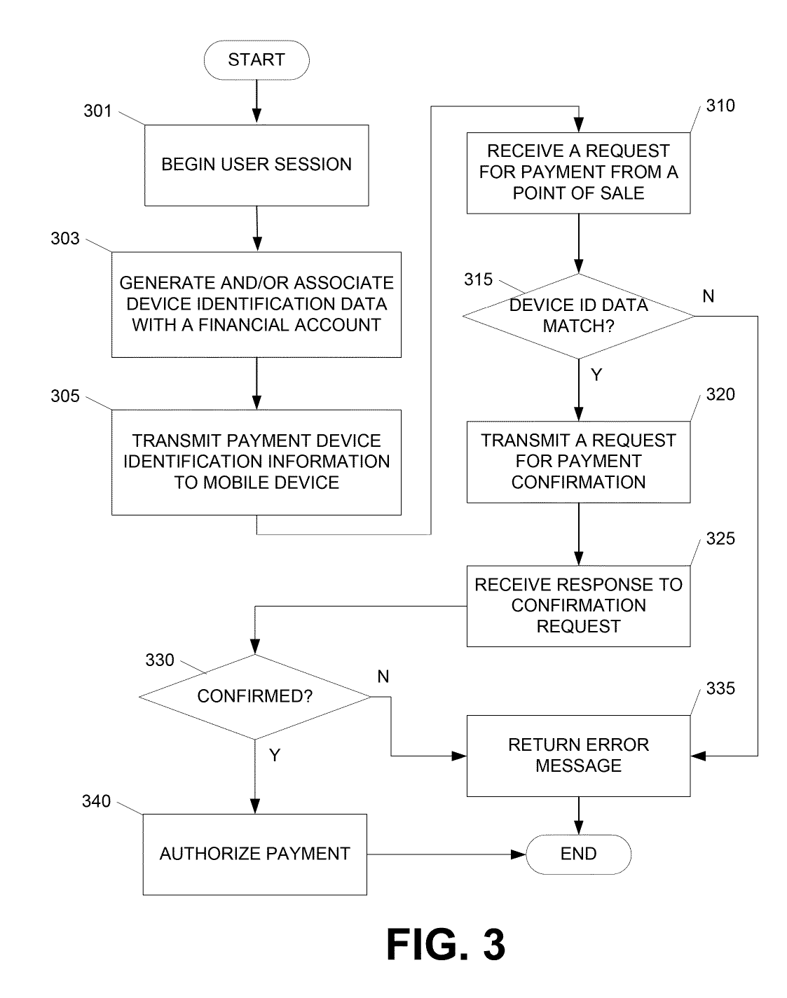

FIG. 3 is a flow chart illustrating a method for making payment at a point of sale using a mobile device. In some embodiments, this method may be used in the exemplary system of FIG. 2. As seen in FIG. 3, in step 301, a customer begins a user session. In some embodiments, a customer may begin the user session by logging into a payment application or interface (e.g., a payment application on the mobile device of the customer) provided by the financial institution. For example, the customer may enter a username, password, account number and/or combinations thereof In some arrangements, the financial institution may be configured to authenticate the customer based on a plurality of usernames and/or passwords. For example, a customer may have a username and/or password for each seller that the customer has authorized the financial institution to transfer funds from the customer account.

In step 303, a financial institution may generate and/or associate device identification data with a financial account of a user (e.g., customer 201). Device identification data may include a mobile phone number, SIM card number, MAC address, device serial number and/or a key or password. For example, the financial institution may generate a random key and provide the random key to the mobile payment device upon the user logging in. In some arrangements, financial institution may determine the device identification data based on the user session (e.g., an alphanumeric sequence determined based on a particular login ID and/or password). Additionally or alternatively, the device identification data may include a generated alphanumeric code (e.g., a randomly generated alphanumeric code). For example, the device identification data may be a randomly generated alphanumeric code. As another example, the device identification data may be the phone number of the customer's mobile device plus another alphanumeric code. In some embodiments, the alphanumeric code may be a cryptographic hash value (e.g., processing the name, username, password, financial account number, etc. of the customer through a cryptographic hash function), a numeric sequence based on GPS information, a string of characters representing the name of customer, the username of the current user session, the password for the current user session, etc. For example, with respect to an illustration where the received data is the phone number of the customer's mobile device (e.g., 555-555-1000) and the alphanumeric code is a randomly generated sequence of alphanumeric characters or a cryptographic hash value (e.g., “a123456789b”), the device identification data may be any of the following: a1255555510003456789b, 5555551000a123456789b, a123456789b5555551000, etc. As another example, with respect to an illustration where the received data is the phone number of the customer's mobile device (e.g., 555-555-1000) and the alphanumeric code is based on GPS information (e.g., an alphanumeric sequence of 415100N0873900W representing a latitude of 41 degrees, 51 minutes and 00 seconds north, and a longitude of 87 degrees, 39 minutes and 00 seconds west), the device identification data may be any of the following: 415100N55555510000873900W, 0873900N5555551000415100W, 415100N0873900W5555551000, 5555551000415100N0873900W, etc.

According to one or more aspects, device identification data may be embodied as a token. In such arrangements, a value for the token is generated for each user session by a system of the financial institution holding the user's account. Accordingly, when a user session is ended, the token may be destroyed/deactivated such that any future fund transfer authorization, as discussed herein, received by financial institution 205 including the value of the token will no longer be valid for that user's account.

The financial institution may store the device identification data in a database in association with the user's financial account information. The financial account may be an account the customer has with the financial institution. For example, the financial account may be a bank account, a credit account number, a savings account, a debit account, etc. In one or more arrangements, the device identification data association process may be performed prior to the user logging into the payment interface. As such, once the user logs in, the device identification data might be already available and stored. In some embodiments, the device identification data may be associated with additional user verification data. Such related to the customer and/or the customer's mobile device. In some arrangements, user verification data may include the Subscriber Identity Module (SIM) card number of the mobile device, the Media Access Control (MAC) address of the mobile device, the address of the customer, a second phone number of the customer (e.g., the customer's home phone number), etc.

In step 305, the financial institution may transmit the payment device identification information to the user's device. This step may be optional if, for example, the user already has knowledge of the identification information (e.g., the device phone number). In other arrangements, the step may be performed so that a user is aware of a session specific key that has been generated.

In step 310, the financial institution system may receive a request for payment from a point of sale system at a retail location or business. The request for payment may include information including an amount owed, an account number of the retailer, items/services purchased as well as identification of a payment device. Payment device identification data, as described herein, may include a mobile phone number, a SIM card number, a MAC address, a key or password or the like.

In step 315, the financial institution system may determine whether the payment device identification information received in the request for payment matches a financial account held by the financial institution. For example, the system may compare the received identification information with the identification information associated with the financial accounts held by the financial institution. If not, an error message may be returned to the point of sale system in step 335. If a match is identified, the financial institution may transmit a request for payment confirmation to a payment device associated with the matching financial account in step 320. In some arrangements, the payment request information may include information corresponding to the user verification data, as discussed in step 303. The financial institution may determine whether the included information matches the information stored in the database. For example, the payment request information may include an address of the customer and the financial institution may determine whether the received address is the same as the address for the customer stored in the database. Additionally or alternatively, the payment request information may include data related to the seller. In these embodiments, the financial institution may determine whether the identified seller corresponds to the current user session. For example, in embodiments where the customer has a plurality of logins and each login corresponds to a particular seller, the financial institution may determine whether the corresponding seller is the same as the seller identified in the payment request information.

In step 325, the financial institution system may receive a response to the confirmation request. In step 330, the system may determine whether confirmation was received or if the payment confirmation request was denied (e.g., a user indicates that the payment is not authorized or confirmed). In one or more arrangements, confirmation of a payment request may include other considerations including determining whether the payment device is within a geographic proximity to the retailer. For example, the payment request information may include a zipcode or an address. The financial institution system may determine a location of the payment device using GPS and determine whether the location of the payment device matches the location information of the retailer. If confirmation is not received, the system may return an error message as illustrated in step 335. If, however, confirmation is received, the system may authorize payment to a financial account of the retailer, initiate the transfer of funds from the customer's financial account to the financial account of the retailer, and provide confirmation to the retailer in step 340.

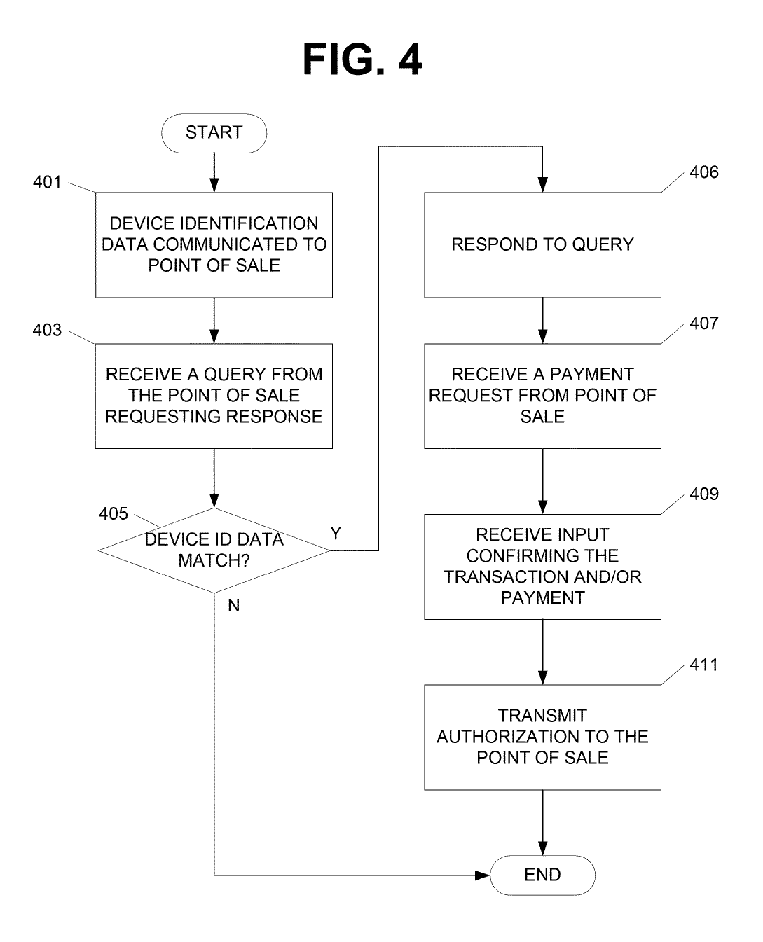

FIG. 4 is a flow chart illustrating a method for processing and completing payment for a purchase using a mobile device at a point of sale. As seen in step 401, the device identification data is communicated to the point of sale. According to aspects of the disclosure, a customer may provide the device identification data to an employee operating the point of sale. As discussed above, examples of the point of sale include a cash register, a personal computer, another mobile device, etc. For example, the customer may display the device identification data on a display of the mobile device so that device identification data may be entered by the employee into the point of sale. As another example, the customer may relay (e.g., speak) the device identification data to an associate of the seller at the point of sale for entry into the point of sale. As another example, customer may provide the device identification data through an input device of the point of transaction (e.g., electronic keypad, touch screen, etc.). One skilled in the art will appreciate that the device identification data may be communicated to the point of sale in a variety of ways.

In step 403, the mobile device may receive a query from the point of sale system requesting a response from a device matching device identification data included in the query. For example, the device identification data may comprise the identification data that was provided to the point of sale system in step 401. Additionally, in some embodiments, the request may include additional information, including, for example, data identifying the seller and/or the point of sale. According to aspects of the disclosure, the communication device may be, for example, a wireless, a Bluetooth® device, and/or infrared device, etc. For example, in some embodiments, the point of sale may transmit a data packet from an infrared device that includes the device identification data (e.g., telephone number of the mobile device), the name of the seller (e.g., name of the retail store the customer and the point of sale are within), and the data required to transmit data to the communication device (e.g., Internet Protocol (IP) address of the communication device).

In step 405, the mobile device may determine whether its device identification data matches the identification data included in the query. If so, the mobile device may respond to the query in step 406. According to aspects of the disclosure, the mobile device may transmit data to the communication device responding to the request (e.g., data acknowledging the request). For example, the response to the request may include data identifying that the mobile device is the device responding to the request, and/or that the request identified the mobile device.

In step 407, the mobile device may receive a payment request from the point of sale system. For example, the payment request may be generated by the point of sale system upon receiving the response to the query from the mobile device. The payment request may include the details of the financial transaction being conducted by the customer at the point of sale. For example, the payment request may include the amount of funds the seller requires from the customer (e.g., the purchase price of the clothing article). In some embodiments, the payment request may include other data related to the transaction, such as data related to the customer (e.g., the name, address, etc. of the customer), data related to the seller (e.g., the name, address, etc. of seller), data related to the goods and/or services being purchased (e.g., the quantity, the unit price, tax, etc), etc. In some embodiments, the mobile device may display data of the received payment request on a display of the mobile device. In these embodiments, the mobile device may provide the customer an opportunity to authorize the received payment request.

In step 409, the mobile device may receive input confirming and/or authorizing the transaction and/or payment therefor. According to aspects of the disclosure, the authorization may be received from the customer. For example, the mobile device may display information related to the received payment request on a display of the mobile device, including the purchase price, the goods and/or services being purchased, and the name of the seller. The customer may consider the displayed information and, if acceptable, accepts the payment request by actuating a button on the mobile device (e.g., a button displayed on the touch-screen of the mobile device).

In step 411, the mobile device may transmit the authorization to the point of sale system. The authorization may include identification of a financial institution, account information, additional user or device identification information (e.g., for additional verification/confirmation) and/or combinations thereof Upon receiving the authorization, the point of sale may complete processing the transaction, including generating and transmitting a request for payment to the financial institution, as discussed above. Optionally, in step 413, the mobile device may receive a payment confirmation verification from a financial institution holding an account of the customer. The payment confirmation verification may request confirmation that a transfer of funds being requested by the point of sale system or retailer is authorized. The mobile device may then determine if confirmation is received (e.g., from a user) in step 415. If so, the mobile device may transmit confirmation verification to financial institution in step 417. If confirmation is not verified, the mobile device may request that the transfer of funds be denied in step 419. As noted, steps 413-419 may be optional if the financial institution of the user, the user, the retailer and/or the financial institution of the retailer does not require further verification.

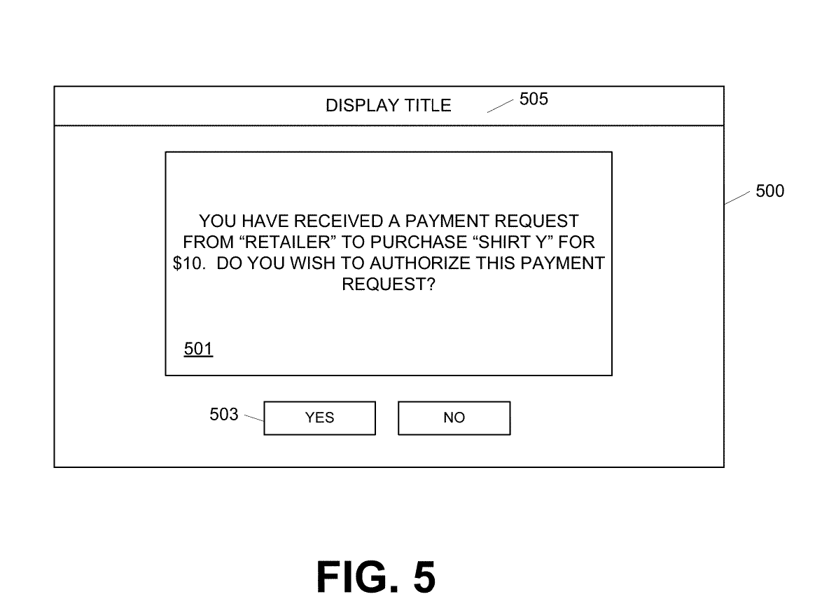

FIG. 5 is an illustration of an exemplary display for a mobile device that may be displayed upon receiving a payment request from a point of sale and/or a payment confirmation request from a financial institution, according to various aspects of the disclosure. As seen in FIG. 5, the display 500 includes a display field 501 where information related to the payment request and/or confirmation request is displayed, buttons 503 that may be actuated by a customer that either accepts or denies the payment request and/or confirmation request, and display title area 505. Upon the customer accepting or denying the payment request and/or confirmation request, the mobile device may transmit data accordingly (e.g., to the point of sale and/or the financial institution).

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

We claim:

1. A method comprising:
determining, by one or more computing devices of a financial institution holding a financial account of a user, a code that is usable to verify a transfer of funds from the financial account and that includes global positioning system information of a mobile device associated with the user;
associating the financial account with the code;
transmitting the code to the mobile device;
electronically receiving, from a point of sale system associated with a seller, a request for transferring an amount of funds from the financial account to an account of the seller, the request including location information of the point of sale system;
verifying the request at least by matching the global positioning system information of the mobile device to the location information of the point of sale system; and
initiating, in response to verifying the request, a transfer of the amount of funds from the financial account to the account of the seller.

2. The method of claim 1, wherein verifying the request includes transmitting a confirmation request to the mobile device and receiving a response to the confirmation request from the mobile device.

3. The method of claim 2, wherein the mobile device is a cellular phone and the code includes a phone number of the cellular phone, wherein the request includes identification information, and wherein verifying the request includes matching the phone number to the identification information.

4. The method of claim 1, further comprising:
receiving login information from the mobile device;
beginning a user session based on the login information, wherein the code is determined in response to the beginning of the user session and wherein the code is active during the user session; and
ending the user session, wherein the code is deactivated upon the ending of the user session.

5. The method of claim 4, wherein the code includes an alphanumeric code generated via a randomized process, wherein the request includes identification information, and wherein verifying the request includes matching the alphanumeric code to the identification information.

6. The method of claim 1, wherein the global positioning information includes a first alphanumeric sequence representing a latitude associated with the mobile device and a second alphanumeric sequence representing a longitude associated with the mobile device.

7. The method of claim 1, wherein transmitting the code to the mobile device enables the mobile device to be usable to communicate with the point of sale system using the code such that the point of sale system transmits the request.

8. The method of claim 1, further comprising:
electronically receiving, at the mobile device, a message that includes data identifying a particular device;
determining whether the message identifies the mobile device based on the data identifying the particular device;
upon determining the data identifies the mobile device, transmitting response data from the mobile device to a communication device as a response to the request;
upon transmitting the response data to the communication device as the response to the request, receiving a payment request from the communication device;
receiving input accepting the payment request; and
in response to receiving the input, transmitting an authorization to the communication device that authorizes the communication device to transmit the request to the financial institution.

9. An apparatus of a financial institution holding a financial account of a user comprising:
a processor; and
memory storing computer readable instructions that, when executed by the processor, cause the apparatus to:
determine a code that is usable to verify a transfer of funds from the financial account of the user and that includes global positioning system information of a mobile device associated with the user;
associate the financial account with the code;
transmit the code to the mobile device;
receive, from a point of sale system associated with a seller, a request for transferring an amount of funds from the financial account to an account of the seller, the request including location information of the point of sale system;
verify the request at least by matching the global positioning system information of the mobile device to the location information of the point of sale system; and
initiate, in response to verifying the request, a transfer of the amount of funds from the financial account to the account of the seller.

10. The apparatus of claim 9, wherein causing the apparatus to verify the request includes causing the apparatus to transmit a confirmation request to the mobile device and receive a response to the confirmation request from the mobile device.

11. The apparatus of claim 10, wherein the mobile device is a cellular phone and the code includes a phone number of the cellular phone, wherein the request includes identification information, and wherein causing the apparatus to verify the request includes causing the apparatus to match the phone number to the identification information.

12. The apparatus of claim 9, wherein the memory further stores computer readable instructions that, when executed by the processor, cause the apparatus to:
receive login information from the mobile device;
begin a user session based on the login information, wherein the code is determined in response to the beginning of the user session, and wherein the code is active during the user session; and
end the user session, wherein the code is deactivated upon the ending of the user session.

13. The apparatus of claim 9, wherein the code includes alphanumeric code generated via a randomized process, wherein the request includes identification information, and wherein causing the apparatus to verify the request includes causing the apparatus to match the alphanumeric code to the identification information.

14. The apparatus of claim 9, wherein the global positioning information includes a first alphanumeric sequence representing a latitude associated with the mobile device, and a second alphanumeric sequence representing a longitude associated with the mobile device.

15. The apparatus of claim 9, wherein causing the apparatus to transmit the code to the mobile device enables the mobile device to be usable to communicate with the point of sale system using the code such that the point of sale system transmits the request.

16. One or more non-transitory computer readable media storing computer readable instructions that, when executed, cause an apparatus of a financial institution holding a financial account of a user to:
determine a code that is usable to verify a transfer of funds from the financial account of the user and that includes global positioning system information of a mobile device associated with the user;
associate the financial account with the code;
transmit the code to the mobile device;
receive, from a point of sale system associated with a seller, a request for transferring an amount of funds from the financial account to an account of the seller, the request including location information of the point of sale system usable to verify the request;
verify the request at least by matching the global positioning information of the mobile device of the location information of the point of sale system; and
initiate, in response to verifying the request, a transfer of the amount of funds from the financial account to the account of the seller.

17. The one or more non-transitory computer readable media of claim 16, wherein causing the apparatus to verify the request includes causing the apparatus to transmit a confirmation request to the mobile device and receive a response to the confirmation request from the mobile device.

18. The one or more non-transitory computer readable media of claim 16, further storing computer readable instructions that, when executed, cause the apparatus to:
receive login information from the mobile device;
begin a user session based on the login information, wherein the code is determined in response to the beginning of the user session, and wherein the code is active during the user session; and
end the user session, wherein the code is deactivated upon the ending of the user session.

19. The one or more non-transitory computer readable media of claim 16, wherein causing the apparatus to transmit the code enables the mobile device to be usable to communicate with the point of sale system using the code such that the point of sale system transmits the request.

20. The one or more non-transitory computer readable media of claim 16, wherein the global positioning information includes a first alphanumeric sequence representing a latitude associated with the mobile device, and a second alphanumeric sequence representing a longitude associated with the mobile device.
